(19) United States
(12) Patent Application Publication
(10) Pub. No.: US 2025/0334225 A1
(43) Pub. Date: Oct. 30, 2025

(54) SPLICE ENCLOSURES AND SLACK MANAGEMENT FOR FIBER OPTIC PEDESTALS

(71) Applicant: Panduit Corp., Tinley Park, IL (US)

(72) Inventors: Kevin M. Zumbek, Palos Heights, IL (US); Jacob L. Chudzik, Frankfort, IL (US); Roman J. Churnovic, Manhattan, IL (US)

(73) Assignee: Panduit Corp., Tinley Park, IL (US)

(21) Appl. No.: 18/783,674

(22) Filed: Jul. 25, 2024

Related U.S. Application Data
(60) Provisional application No. 63/638,539, filed on Apr. 25, 2024.

(51) Int. Cl. F16M 13/02; G02B 6/44

(52) U.S. Cl. CPC F16M 13/02; G02B 6/4454

(57) ABSTRACT

A mounting bracket for use in a fiber optic access pedestal has a top flange, a bottom flange, and a pair of slide flanges configured to retain a looped cable within the with a bend radius that is not detrimental to cable performance.

### CROSS REFERENCE TO RELATED APPLICATION(S)

This application claims priority to U.S. provisional application No. 63/638,539 filed on Apr. 25, 2024, the entirety of which is hereby incorporated by reference herein.

### FIELD OF INVENTION

The present disclosure relates generally to splice enclosures and slack management for fiber optic pedestals and more specifically to a mounting bracket for a splice enclosure that is capable of storing excess cable in one or more loops with a bend radius that is not detrimental to cable performance.

### BACKGROUND

When splice trays are attached within an enclosure, there is a risk that a splice tray may come loose during handling by the end user which may result in damage to the fibers. Additionally, the fiber cables within the enclosure each include a central strength member which must be secured to prevent movement and potential damage to nearby fibers.

Some fiber networks may be designed to utilize multiport service terminals (MST) or third-party splice or connector enclosures. These may be designed such that the MST fiber cable must be spliced to the distribution cable in close proximity to the MST.

Pedestals used as access terminals for communications cable do not typically provide space to store slack of the complete, jacketed cable. Therefore, any slack of the cable stored within the pedestal must have the outer jacket, armor, protective layers, and central member removed, leaving the more compact internal wire or fiber and buffer tube slack to be stored inside the pedestal. Any additional jacketed cable slack must be stored elsewhere-outside the pedestal-else the technicians must plan to eliminate cable slack when installing the buried cable into the ground. While some pedestals may provide space to accommodate cable slack, they lack the specific features needed to secure a larger loop of communications cabling due to the amount of force needed to bend and hold the cabling loop into the exact loop shape that fits within the pedestal. Without cable slack and a removeable enclosure or splice holder, the splicing technician must perform all splicing work at the pedestal location which may be difficult when the pedestal is located in a location that is hard to reach or during inclement weather. What is needed is an access terminal pedestal with space and provisions to support jacketed cable slack and a removable splice enclosure such that splicing of the cabling may occur away from pedestal.

### SUMMARY

A mounting bracket for use in a fiber optic access pedestal has a top flange, a bottom flange, and a pair of slide flanges configured to retain a looped cable with a bend radius that is not detrimental to cable performance.

### BRIEF DESCRIPTION OF THE DRAWINGS

FIG. 1 is a trimetric view of splice organizer 20, which is a sub assembly of enclosure 78 shown in FIG. 7.

FIG. 2 is Detail A of FIG. 1. Splice tray 30 includes hinge pin 40 and strengthening plate 32.

FIG. 3 is a rear trimetric, partially exploded view of splice receptacle 26 and splice tray lock 28 showing keyhole 44 and splice tray lock pin 42.

FIG. 4 is a trimetric view of splice plate 38, distribution cable strength member clamp 34, hose clamp cutout 36, grommet 46, distribution cable 48 and distribution cable strength member 50.

FIG. 5 is a trimetric view of drop plate 60 which includes cable tie cutout 58, drop cable guide 64 and drop cable strength member clamp 66.

FIG. 6 is a trimetric view of small pedestal mounting bracket 72 and small fiber optic pedestal 70 with pedestal cover and splice enclosure 78 removed for clarity.

FIG. 7 is a rear trimetric, exploded view of small pedestal mounting bracket 72 and splice enclosure 78.

FIG. 8 is a trimetric view of alternate embodiment small fiber optic pedestal 70 and splice organizer 20 mounted directly to small pedestal mounting bracket 72.

FIG. 9 is a trimetric view of fiber optic pedestal 122, multiport service terminal (MST) 123, universal mounting bracket 120, splice tray 126, and single tray splice organizer 124 with pedestal cover not shown for clarity.

FIG. 10 is a detailed view of single tray splice receptacle 128, single tray splice lock 130 and splice tray 126.

FIG. 11 is a front view of fiber optic pedestal 122, single tray splice organizer 124 and adapter bracket 132 with pedestal cover and universal mounting bracket 120 not shown for clarity.

FIG. 12 is an exploded view of universal mounting bracket 120 and adapter bracket 132.

FIG. 13 is a front view of large pedestal 210, splice enclosure 222, mounting bracket 224 and communications cable 226 with pedestal cover and pedestal base removed for clarity.

FIG. 14 is a trimetric view of mounting bracket 224 containing communications cable 226 slack loop.

FIG. 15 is a side view of splice enclosure 222 and mounting bracket 224.

### DESCRIPTION OF INVENTION

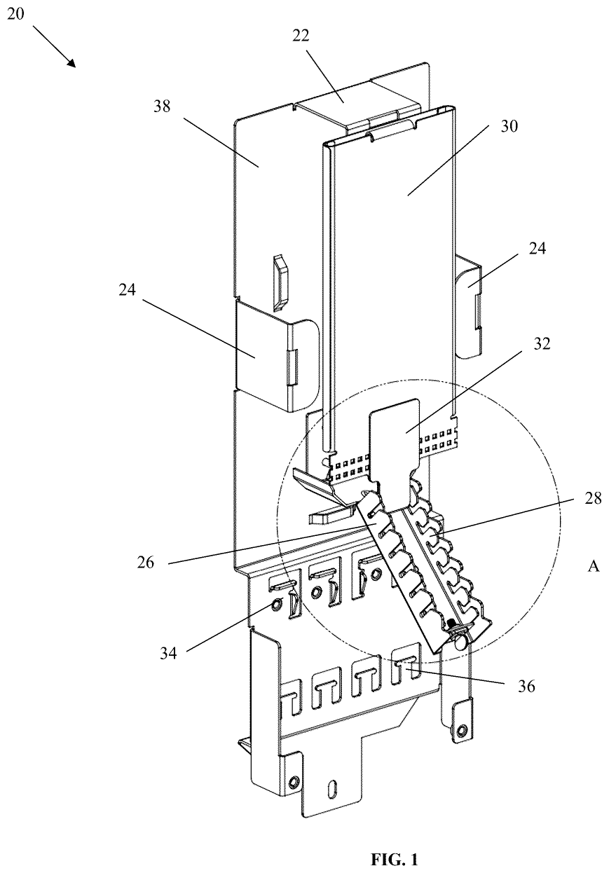

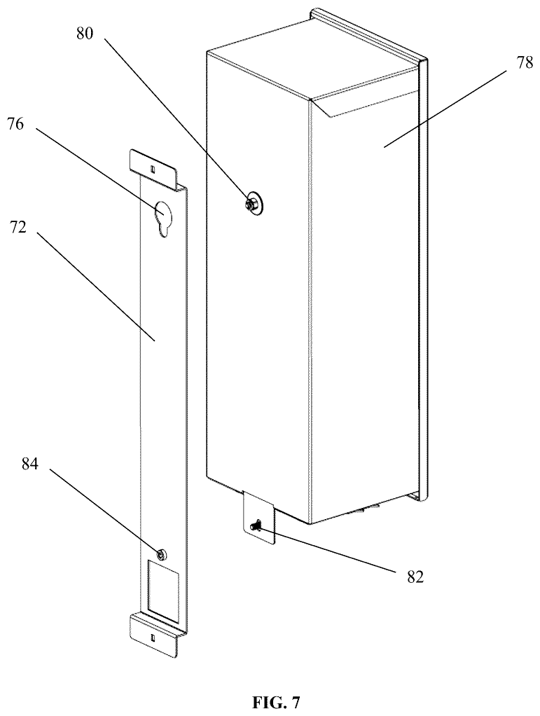

FIG. 1 is a trimetric view of splice organizer 20, which is a sub assembly of enclosure 78 shown in FIG. 7. Splice organizer 20 includes splice plate 38, splice receptacle 26 and splice tray lock 28. Splice plate 38 includes top buffer tube flange 22 and side buffer tube flanges 24 to contain buffer tube slack storage. Top buffer tube flange 22 also supports splice tray 30 when in the upright position. Splice plate 38 also includes distribution cable strength member clamp 34 and hose clamp cutout 36.

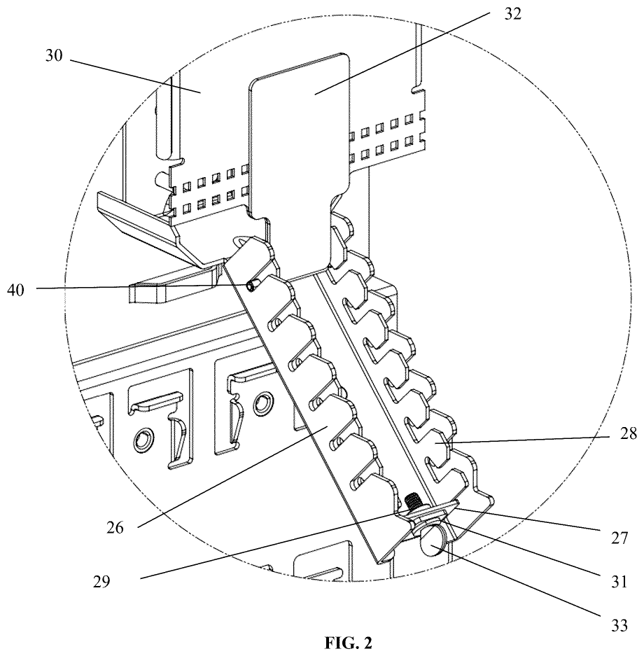

FIG. 2 is Detail A of FIG. 1. Splice tray 30 includes hinge pin 40 and strengthening plate 32. Splice tray 30 inserts into splice receptacle 26 and splice tray lock 28 with hinge pin 40 allowing splice tray 30 to tilt forward about ninety-degrees. Splice receptacle 26 includes a flange 27 and nut 29. Splice tray lock 28 includes a flange 31. Thumb screw 33 inserts through flange 26 and threads into nut 29 to secure the components together.

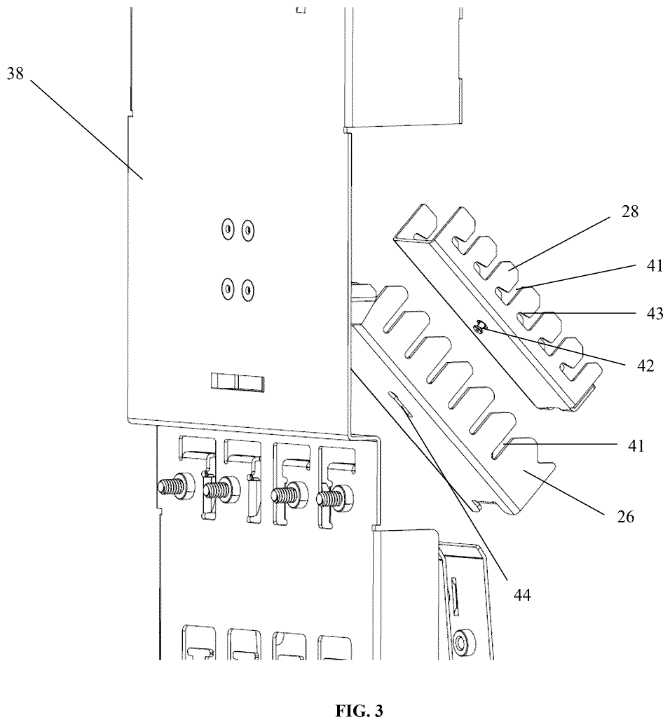

FIG. 3 is a rear trimetric, partially exploded view of splice receptacle 26 and splice tray lock 28 showing keyhole 44 and splice tray lock pin 42. Splice tray lock 28 secures to splice receptacle 26 with splice tray lock pin 42. Keyhole 44 and thumb screw 33 both have ample length to permit relative motion between splice tray lock 28 and splice receptacle 26 in the parallel direction without disconnection. Splice tray lock 28 and splice receptacle 26 both include perpendicular slots 41 which can be aligned when thumb screw 33 is loosened and splice tray lock 28 is moved upward, allowing hinge pin 40 of splice tray 30 to be inserted into or to be removed from splice receptacle 26. Splice tray lock 28 also includes parallel slots 43 that extend from the bottom of perpendicular slots 41. When splice tray lock 28 is moved to its lowest position, hinge pin 40 is captured between parallel slots 43 of splice tray lock 28 and perpendicular slots 41 of splice receptacle 26. Thumb screw 29 can be tightened to lock splice tray 30 in place.

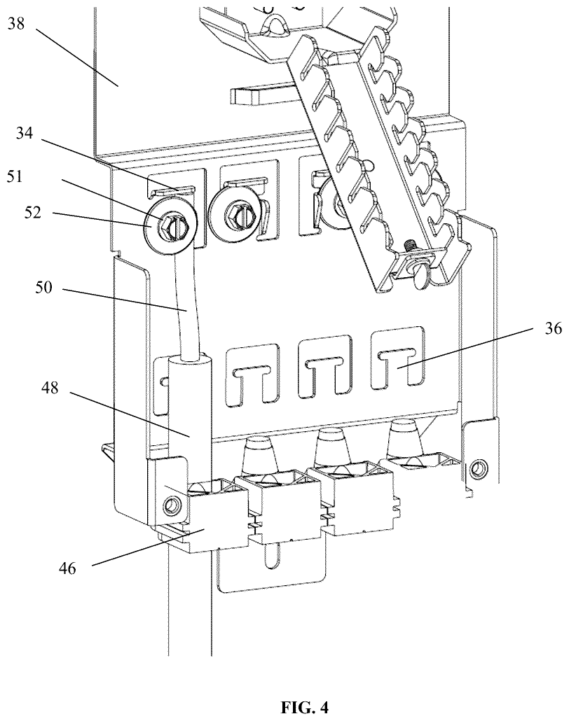

FIG. 4 is a trimetric view of splice plate 38, distribution cable strength member clamp 34, hose clamp cutout 36, grommet 46, distribution cable 48 and distribution cable strength member 50. Distribution cable 48 egresses through grommet 46 and is clamped with a hose clamp (not shown) to hose clamp cutout 36. Distribution cable 48 outer jacket is stripped exposing fiber buffer tubes (not shown for clarity) and distribution cable strength member 50. Screw 51 threads into splice plate 38 in order to compress distribution cable strength member 50 is between distribution cable strength member clamp 34 and washer 52 and prevent relative motion between the components.

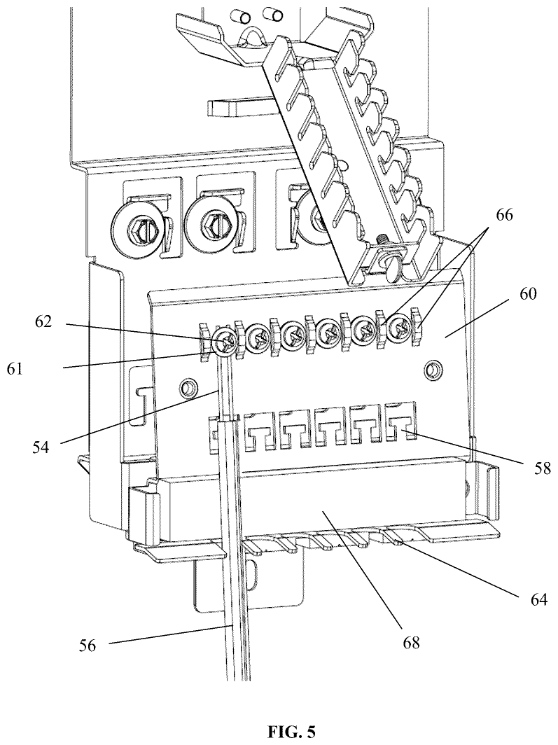

FIG. 5 is a trimetric view of drop plate 60 which includes cable tie cutout 58, drop cable guide 64 and drop cable strength member clamp 66. Drop cable 56 egresses between foam 68 on drop plates 60. Drop cable 56 outer jacket is stripped exposing fiber buffer tube (not shown for clarity) and drop cable strength members 54. Drop cable 56 is secured with a cable tie (not shown) to cable tie cutout 58. Drop cable strength member 54 is fastened between drop cable strength member clamp 66 with screw 62 and washer 61.

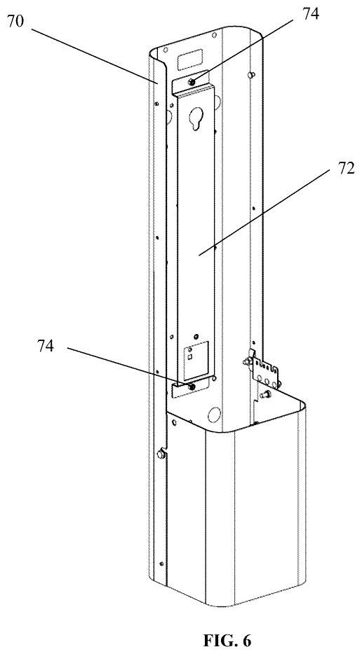

FIG. 6 is a trimetric view of small pedestal mounting bracket 72 and small fiber optic pedestal 70 with pedestal cover and splice enclosure 78 removed for clarity. Small pedestal mounting bracket 72 mounts to fiber optic pedestal with fasteners 74 utilizing existing holes.

FIG. 7 is a rear trimetric, exploded view of small pedestal mounting bracket 72 and splice enclosure 78. Splice enclosure 78 utilizes standard fasteners 80 to create a “hook” that inserts into keyhole 76 for ease of installation. Splice enclosure 78 will also secure to small pedestal mounting bracket 72 by fastening screw 82 to threaded nut 84.

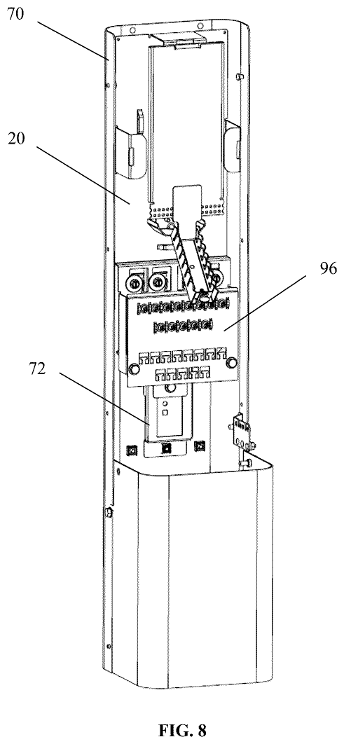

FIG. 8 is a trimetric view of alternate embodiment small fiber optic pedestal 70 and splice organizer 20 mounted directly to small pedestal mounting bracket 72. In this embodiment, large drop plate 96 is installed directly to splice organizer 20 to accommodate more drop cable installations on one drop plate in lieu of using two drop plates 60.

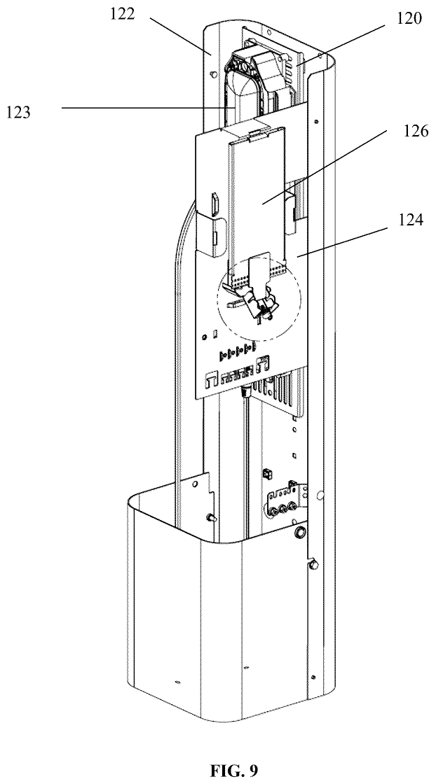

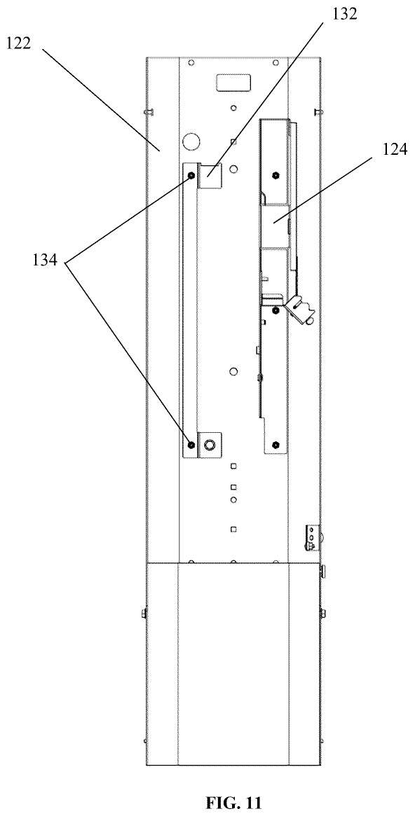

FIG. 9 is a trimetric view of fiber optic pedestal 122, multiport service terminal (MST) 123, universal mounting bracket 120, splice tray 126, and single tray splice organizer 124 with pedestal cover not shown for clarity. Single tray splice organizer 124 can mount to fiber optic pedestal 122 with standard fasteners (not shown). Universal mounting bracket 120 mounts to adapter bracket 132 (shown in FIG. 11).

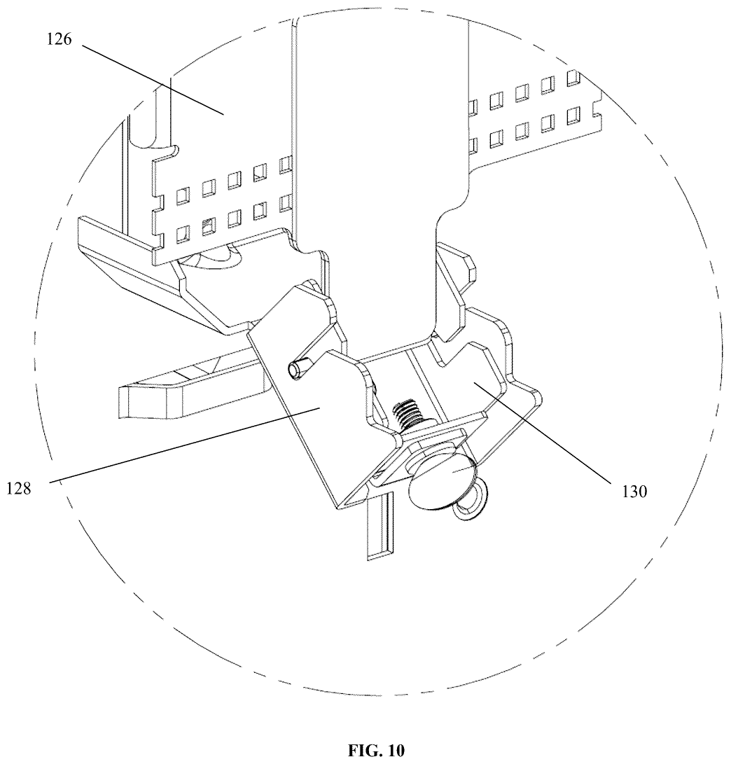

FIG. 10 is a detailed view of single tray splice receptacle 128, single tray splice lock 130 and splice tray 126. Single tray splice receptacle 128, single tray splice lock 130 only support one splice tray in order to allow for more space inside fiber optic pedestal 122 for mounting multiport service terminal 123. One splice tray 126 supports up to 24 splices of MST fibers to the distribution cable.

FIG. 11 is a front view of fiber optic pedestal 122, single tray splice organizer 124 and adapter bracket 132 with pedestal cover and universal mounting bracket 120 not shown for clarity. Adapter bracket 132 mounts to fiber optic pedestal 122 with fasteners 134.

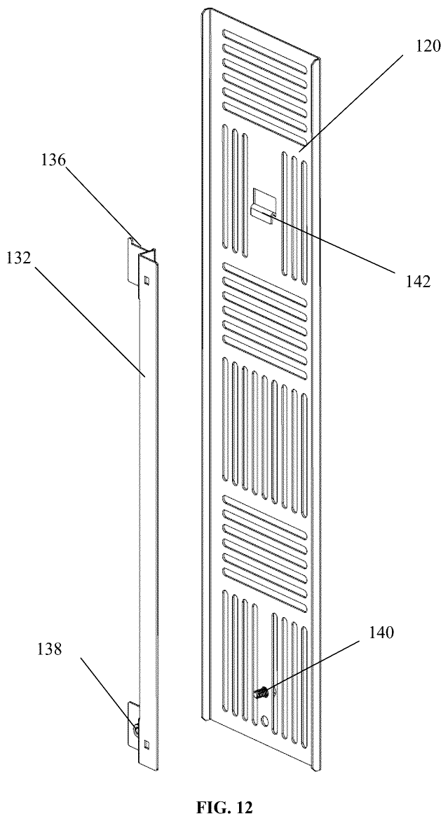

FIG. 12 is an exploded view of universal mounting bracket 120 and adapter bracket 132. Universal mounting bracket 120 hooks on to adapter bracket cutout 136 with mounting hook 142. Universal mounting bracket 120 also fastens to threaded nut 138 with screw 140.

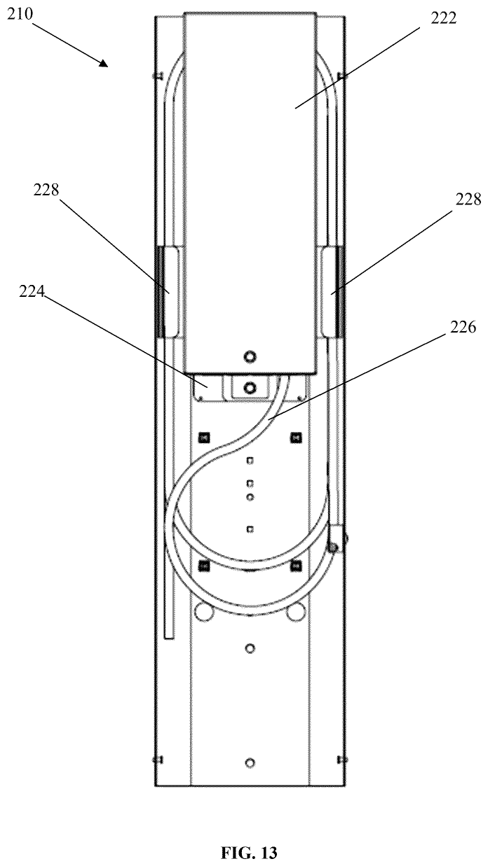

FIG. 13 is a front view of large pedestal 210, splice enclosure 222, mounting bracket 224 and communications cable 226 with pedestal cover and pedestal base removed for clarity. Mounting bracket 224 allows for installation of splice enclosure 222 with slack storage for communication cabling 226. Communications cable 226 is buried underground and enters large pedestal 210 through the bottom. Excess cable slack is then stored within mounting bracket 224.

Then communications cable 226 enters bottom of splice enclosure 222. All splicing and cutting or penetrations into communications cable 226 occurs within splice enclosure 222. Flanges 228 on each side of mounting bracket 224 retain communications cable 226 slack loop within large pedestal 210 and withhold expanding force exerted by the communications cable 226 loop due to compression of loop into an oval shape. The large pedestal 210 form factor provides space for a slack loop with a bend radius that is not detrimental to cable performance including, but not limited to, 72-fiber non-armored cable.

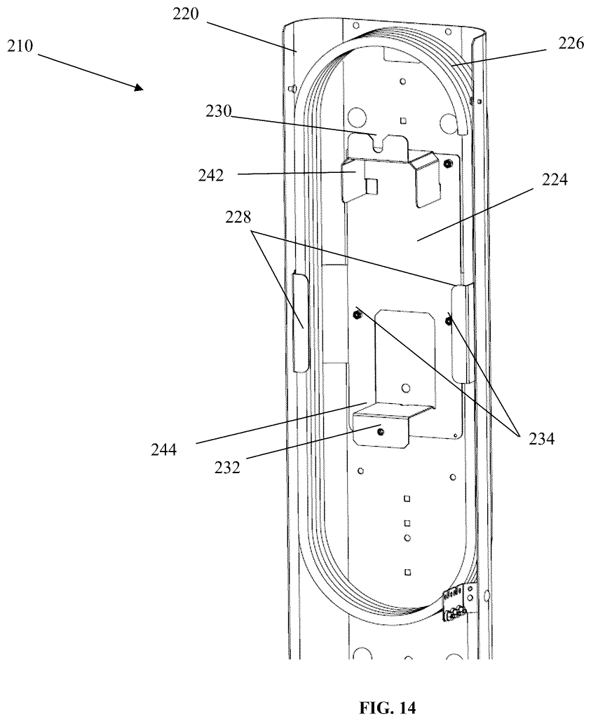

FIG. 14 is a trimetric view of mounting bracket 224 containing communications cable 226 slack loop. Flanges 228 conform to large pedestal backbone 220 and contain slack loops. Top flange cutout 230 on top flange 242 and threaded nut 232 on bottom flange 244 are used for installing splice enclosure 222. Mounting bracket 224 attaches to large pedestal backbone 220 with fasteners 234 through existing holes on large pedestal 210.

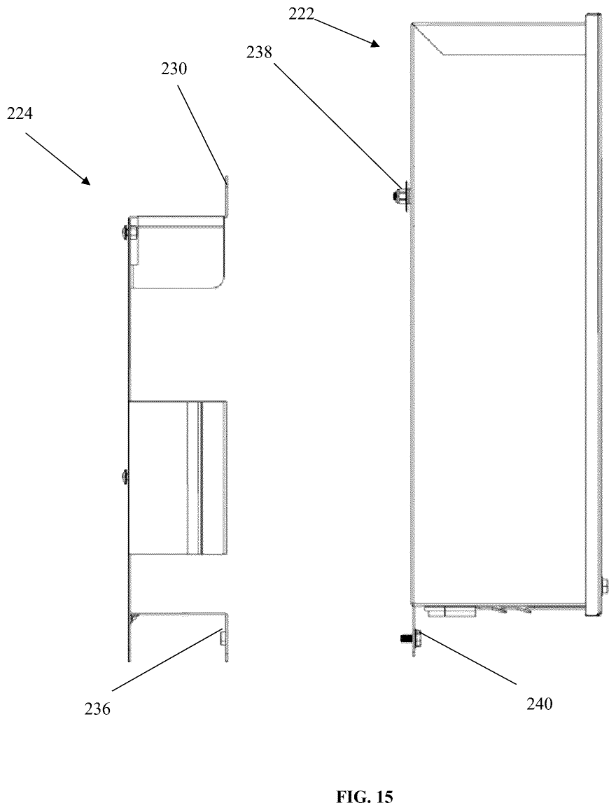

FIG. 15 is a side view of splice enclosure 222 and mounting bracket 224. Splice enclosure 222 “hooks” into top flange cutout 230 with fastener hook 238 and fastens to threaded nut 236 with standard fastener 240 which allows splicing technicians to easily remove splice enclosure 222 from the pedestal to splice internal cabling at remote locations as far as permitted by the length of slack of communications cable 226. Splice enclosure 222 hooking onto mounting bracket 224 allows for ease of reinstallation after the splicing is complete.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A mounting bracket for use within a fiber optic access pedestal comprising:
a top flange a bottom flange; and
a pair of slide flanges configured to retain a looped cable within the pedestal with a bend radius that is not detrimental to cable performance.

2. The mounting bracket of claim 1 further being configured to have a splice enclosure mounted on the mounting bracket.

3. The mounting bracket of claim 2 further comprising a top flange cutout and a threaded nut on the bottom flange for mounting the splice enclosure.
